(19) United States
(12) Patent Application Publication
(10) Pub. No.: US 2004/0064298 A1
(43) Pub. Date: Apr. 1, 2004

(54) Medical instruction using a virtual patient

(76) Inventor: Robert Levine, Sunny Isles, FL (US)

Correspondence Address: LERNER AND GREENBERG, P.A., POST OFFICE BOX 2480, HOLLYWOOD, FL, 33022-2480, US

(21) Appl. No.: 10/673,743

(22) Filed: Sep. 26, 2003

Related U.S. Application Data
(60) Provisional application No. 60/413,821, filed on Sep. 26, 2002.

(51) Int. Cl. G06G 7/58; G06G 7/48; G09B 23/28

(52) U.S. Cl. 703/11; 434/262

(57) ABSTRACT

A virtual patient simulates the onset, diagnosis and treatment of all major medical conditions via a medical instructional console. The multimedia simulation, complete with video and audio, allows the patient to develop symptoms, answer questions, and undergo physical examination, monitoring, laboratory and radiological evaluation. The virtual patient responds realistically to medical interventions and visualizes medical ailments and treatments from “within”. Exemplary organs available for visualization include a beating heart, flowing blood, breathing lungs and a thinking brain. Medical conditions include clots forming and emblazing, lungs collapsing, and the heart being defibrillated. The virtual patient provides a complete human body heretofore impalpable, allowing a user to navigate throughout the human body, observing the organs in simulated motion during both normal and pathological physiology, while demonstrating the internal effects of medications and procedures on these organs.

### CROSS-REFERENCE TO RELATED APPLICATION

This application claims the benefit of the provisional application 60/413,821 originally filed Sep. 26, 2002 under 35 U.S.C. 119(e).

### FIELD OF THE INVENTION

The present invention relates to medical instruction. More particularly, the present invention relates to using a dynamic virtual patient to graphically illustrate symptomatology, diagnosis, and treatment of many common medical conditions.

### BACKGROUND AND RELATED ART

Developing an understanding of human anatomy, physiology and illness has traditionally been visually supplemented by a series of still images via anatomical illustration, cadaver dissection, or static radiographic imaging. Static anatomical models of various types, such as plastic organs, have also been used to supplement the human model.

Unfortunately, a static picture does not always convey the necessary information for complete medical instruction. For example, a curriculum which focuses on still images and dissection does not always provide useful assistance to healthcare professionals seeking instruction or a brief tutorial on unfamiliar procedures, such as “seeing the cords” during street intubations.

In view of still images and static models previously associated with medical instruction and the various limitations of available software that is based solely on these static models, several groups have attempted to develop exhaustive computer systems, which define a static human body physiology at all morphological levels and anatomic sites. Unfortunately, none of these available systems can provide an integrated dynamic virtual human body. For example, available software that attempts to simulate human patient anatomy fails to incorporate accurate dynamic physiology.

### SUMMARY OF THE INVENTION

Medical instruction using a virtual patient has been developed in response to the current state of the art, and in particular, in response to these and other problems and needs that have not been fully or completely solved by currently available static anatomy instructional systems for medicine. More specifically, the virtual patient allows a user to navigate throughout the human body, observing the organs in simulated motion during both normal and pathological physiology, while demonstrating the internal effects of medications and procedures on these organs.

The described virtual patient may provide a medical condition to be discovered and treated or merely reflect healthy responses. In performing a simulated medical examination, the user may uncover indicators related to the virtual patient's medical condition. The virtual patient may also provide an internal visualization of the human body and various systems to aid in the determination of the medical condition. Accordingly, the system may also administer at least one course of treatment to the virtual patient. The virtual patient responds according to the effectiveness of the treatment for the medical condition.

In one embodiment, the virtual patient forms the basis of an interactive program “The Virtual Medical Chart” that allows an individual to chronicle a desired timeline of medical care for an individual patient and re-enact a patient's medical history from presentation to evaluation to diagnosis to treatment and, finally, to outcome. One particular use of this embodiment is the presentation of a patient's condition during past treatment by a medical expert witness at trial.

Another embodiment provides a student with a dynamic virtual patient having various mystery ailments or medical conditions. As the student performs a medical evaluation of the virtual patient, the instructional processing device determines whether the student needs to be prompted by animated images of the relevant organs and systems. At the student's request, the instructional processing device may also retrieve vital signs, heart rhythms, x-rays, simulated lung sounds, and other medical indicators consistent with the mystery illness.

Another embodiment is useful in an instructor guided seminar with a large audience, such as a class of students. The instructor creates a dynamic virtual patient having a specific medical condition and together with audience input, guides the patient through a simulated medical evaluation and course of treatment. The audience is then encouraged to evaluate the patient by asking questions, to which the figure will nod negatively or affirmatively by the instructor striking the proper keyboard keys. The instructor can worsen the patient's condition, e.g., have the pain radiate to the arm, have the patient sweat or even collapse if the appropriate simulated interventions (e.g. place IV, place patient on a cardiac monitor) are not suggested in a timely manner by the audience. A clock on the screen can be set to run in real time or may be manipulated by the instructor to simulate alternative time patterns. ***

It is accordingly an object of the invention to provide a medical instruction method, system, and apparatus that overcome the hereinafore-mentioned disadvantages of the heretofore-known devices of this general type and that provide dynamic virtual patients to graphically teach symptomatology, diagnosis, and treatment of various medical conditions.

With the foregoing and other objects in view, there is provided, in accordance with the invention, a method including the steps of electronically determining a medical condition for a virtual patient, electronically simulating a medical examination on the patient, and electronically administering at least one course of treatment on the virtual patient.

In accordance with another mode of the invention, the step of simulating the medical examination includes providing dynamic internal views and external views of organs and systems associated with the medical condition.

In accordance with a further mode of the invention, there is provided the step of selecting the medical condition from at least one of cardiac arrest, ACS/AMI, CHF, DVT/PE, aortic dissection, pericardial tamponade, pneumothorax (tension & simple), asthma, pneumonia, appendicitis, AAA, perforated viscous, GI bleed (upper & lower), bowel obstruction, mesenteric ischemia, cholycystitis, renal colic, testicular torsion, TIA/CVA, seizure, and meningitis.

In accordance with an added mode of the invention, there is provided the step of simulating the at least one course of treatment includes medicating the virtual patient and providing dynamic internal views and external views of organs and systems affected by an administered medication.

In accordance with an additional mode of the invention, there is provided the step of selecting the medication used in medicating the virtual patient from at least one of saline, adenosine, nitroprusside, dilitazem, epinephrine, amiodarone, thrombolytics, atropine, heparin, enoxaparin, furosemide, beta blocker, nitroglycerine, and aspirin.

In accordance with yet another mode of the invention, there is provided the step of visually indicating, with the virtual patient at least one location of pain associated with the medical condition during the medical examination.

In accordance with yet a further mode of the invention, the step of electronically providing the medical condition includes altering a severity of the medical condition according to one of the at least one course of treatment and a timeliness of response in administering at least one preferred course of treatment.

In accordance with yet an added mode of the invention, the simulated medical examination includes performing ancillary testing selected from the group consisting of x-rays, CT scans, MRIs, EKGs, and laboratory data.

In accordance with yet an additional mode of the invention, the step of simulating the at least one course of treatment includes performing a procedure selected from the group consisting of CPR, defibrillation, needle decompression, EKG, and intubations.

With the objects of the invention in view, there is also provided a system for indicating an electronic dynamic human body and simulating interactive patient care and treatment, the system including an instructional database containing data for at least one medical condition having dynamic internal views and external views of organs and systems relevant to the medical condition and data for at least one patient profile, an instructional processing device electronically connected to the instructional database, the processing device being configured to generate a virtual patient from the data of a selected patient profile and to simulate a medical examination and at least one course of treatment, and an input control device electronically connected to the processing device for generating control signals to interact with the virtual patient and to alter the simulated medical examination and the simulated at least one course of treatment.

In accordance with again another feature of the invention, there is provided a display device configured to visualize the effects of the simulated medical examination and the simulated at least one course of treatment on the virtual patient via dynamic internal views and external views of organs and systems.

In accordance with again a further feature of the invention, there are provided a communications network electronically connected to the instructional processing device and multiple instructional consoles electronically connected to the communications network, each console observing the virtual patient and the simulated medical examination and the simulated at least one course of treatment.

In accordance with again an added feature of the invention, the multiple instructional consoles each provide feedback containing a suggested course of treatment to the instructional processing device.

In accordance with again an additional feature of the invention, the instructional processing device includes a clock and the virtual patient is generated from data based on a real patient medical history, the virtual patient receiving the at least one course of treatment provided in the medical history.

With the objects of the invention in view, there is also provided an apparatus for medical instruction, including a machine readable medium containing instructions which, when executed by a machine, cause the machine to perform operations including generating a medical condition for a virtual patient and administering a simulated medical examination on the patient, the simulated medical examination having dynamic internal views and external views of organs and systems relevant to the medical condition.

In accordance with still another feature of the invention, the machine-readable medium contains instructions that cause the machine to administer at least one course of treatment on the virtual patient based in part on the simulated medical examination.

In accordance with still a further feature of the invention, the at least one course of treatment includes medicating the virtual patient.

In accordance with still an added feature of the invention, the machine-readable medium contains instructions that cause the machine to observe the simulated effect of medicating the virtual patient on the medical condition with at least one dynamic internal view and at least one external view.

In accordance with still an additional feature of the invention, the simulated medical examination is conducted according to information provided in a medical history of a real patient and the reactions of the virtual patient correspond to the reactions recorded in the medical history.

In accordance with a concomitant feature of the invention, the machine-readable medium contains instructions that cause the machine to alter a severity of the medical condition according to timeliness of response in providing a preferred course of treatment.

Other features that are considered as characteristic for the invention are set forth in the appended claims.

Although the invention is illustrated and described herein as embodied in a medical instruction method, system, and apparatus, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

Additional features and advantages of medical instruction with a virtual patient will be set forth in the description that follows, and in part will be obvious from the description, or may be learned by the practice of medical instruction using a virtual patient. The features and advantages of medical instruction with a virtual patient may also be realized and obtained by the instruments and combinations particularly pointed out in the appended claims.

### BRIEF DESCRIPTION OF THE DRAWINGS

The patent or application file contains at least one drawing executed in color. Copies of this patent or patent application with color drawings will be provided by the Office upon request and payment of the necessary fee.

The embodiments of the invention are illustrated by way of example, and not by way of limitation, in the figures of the accompanying drawings in which like reference numerals refer to similar elements. In the drawings:

FIG. 1 is a block circuit diagram of a first embodiment of a suitable operating environment for a medical instruction system using a virtual patient according to the invention;

FIG. 2 is a block circuit diagram of a second embodiment of a suitable operating environment for a medical instruction system according to the present invention;

FIG. 3 is a block circuit diagram of a third embodiment of a suitable operating environment for a medical instruction system according to the invention;

FIG. 4 is a fragmentary perspective view from above the virtual patient according to the invention exhibiting abdominal pain;

FIG. 5 is a fragmentary perspective and partially broken away view from a side of the virtual patient according to the invention exhibiting a herniated disk;

FIG. 6 is a fragmentary, enlarged perspective view of the herniated disk of FIG. 5;

FIG. 7 is a fragmentary, plan view of the virtual patient according to the invention connected to a telemetry box including a cardiac monitor;

FIG. 8 is a fragmentary, plan view of the virtual patient according to the invention with an external pacer and a cardiac monitor;

FIG. 9 is a fragmentary plan view of a virtual heart according to the invention;

FIG. 10 is a cross-sectional view of the virtual heart according to the invention showing electrical conduction with a cardiac monitor showing a rhythm of the virtual heart;

FIG. 11 is a fragmentary plan and partially broken away view of the virtual patient according to the invention with fragmentary hands administering CPR to the virtual patient;

FIG. 12 is a fragmentary plan and partially broken away view of the virtual patient according to the invention with treatment of pericardial centesis;

FIG. 13 is a fragmentary plan and partially broken away view of the virtual patient with the telemetry box including a cardiac monitor according to the invention, the virtual patient exhibiting visual symptoms;

FIG. 14 is a fragmentary plan and partially broken away view of cardiopulmonary physiology in the virtual patient according to the invention;

FIG. 15 is a fragmentary plan and partially broken away view of intubations of the virtual patient according to the invention;

FIG. 16 is a fragmentary plan view of intravenous infusion of the virtual patient according to the invention; and

FIG. 17 is a flow chart of a medical instruction control process according to the invention.

### DETAILED DESCRIPTION

In the following description, numerous specific details are set forth. However, it is understood that embodiments of the invention may be practiced without these specific details. In other instances, well-known hardware and software modules, structures, and techniques have not been shown in detail in order not to obscure the understanding of this description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment.

A machine-accessible medium includes any mechanism that provides (i.e., stores and/or transmits) information in a form readable by a machine (e.g., a computer). For example, a machine-accessible medium includes read only memory (ROM), random access memory (RAM), magnetic disk storage media, optical storage media, flash memory devices, electrical, optical, acoustical or other form of propagated signals (e.g., carrier waves, infrared signals, digital signals), etc.

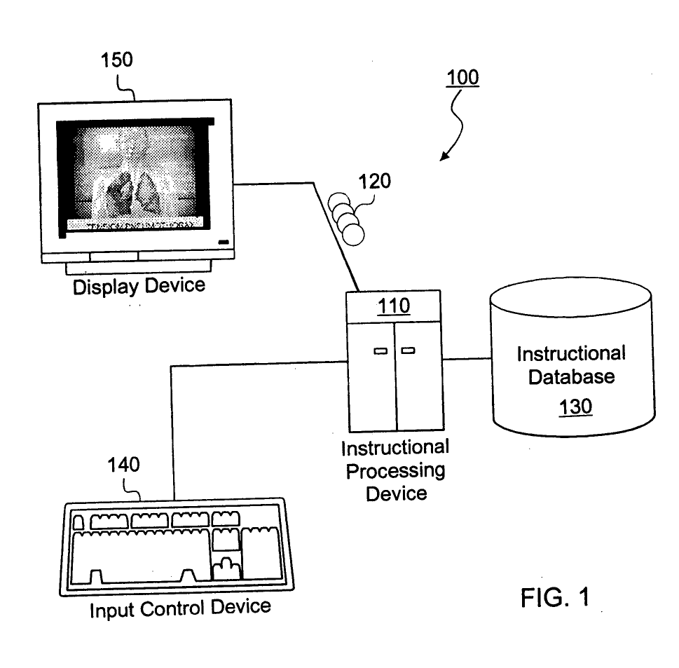

FIG. 1 and the following discussion are intended to provide a brief, general description of a suitable operating environment or instructional console 100 that includes an instructional processing device 110 for processing data 120 originally stored in an instructional database 130. Exemplary instructional consoles include an application specific electronic device, a general-purpose computer, Set-Top Boxes (STBs), or other specialized multimedia educational centers.

The instructional console 100 receives control signals from at least one input control device 140. Exemplary input devices include sound activated controllers, light activated controllers, pressure activated controllers, movement activated controllers, and other Input/Output (I/O) devices, such as mice, keyboards, game controllers, scanners, touchpads, or other input device. Upon processing the data 120, the instructional console 100 typically transmits a media signal to a display device 150, such as a monitor and/or a television. The media signal may include data, audio, and video signals. This configuration is useful in one-on-one and small group instruction and counseling. In one embodiment, a compact portable digital device, such as a laptop or PDA, provides the necessary operational requirements to function as an instructional console 100, making the virtual patient extremely portable.

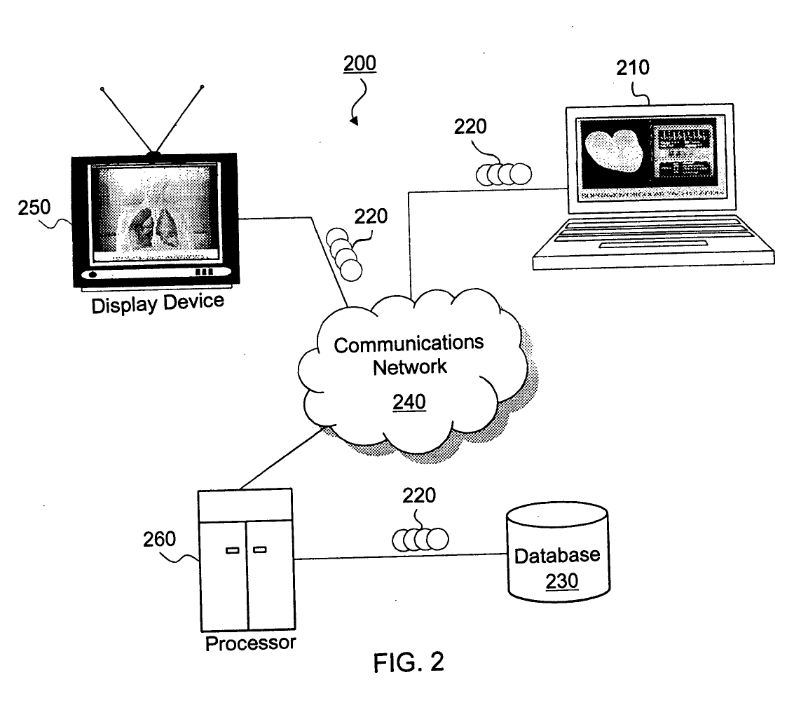

FIG. 2 illustrates another suitable operating environment of a medical instruction system 200. The system 200 includes an instruction control console 210 for retrieving data packets 220 from an instructional database 230 via a communications network 240 for display on a remote display device 250. The display device 250 may also be connected directly to either the instruction control console 210 or the instructional processing device 260.

In one embodiment, the instruction control console 210 accesses a remote instructional processing device 260 with a query for relevant data 220. The instructional processing device generates the necessary database request for data 220 from the instructional database 230. This configuration is useful when providing a medical presentation of a particular case to a single group, such as expert testimony. Movie clips and other dynamic illustrations may be retrieved based on the particular events within the medical history.

In one configuration, where the individual providing the medical instruction does not necessarily know the scope of questions in advance, a portion of the data packets 220 may be retrieve from a prepared presentation on the instruction control console 210 and the remaining portion retrieved from the remote database 230 via the communications network 240. Exemplary communications networks include wireless networks, private networks, dedicated networks, Internet, intranet, or combinations thereof.

While FIG. 2 only illustrates one medical instruction system 200, several other configurations are acceptable and within the scope of at least one embodiment. For example, an embodiment using more than one display device would also benefit from the previously described system 200. Yet another possible configuration uses a distributed database 230 associated with numerous instructional processing devices 260. Nor do the embodiments need be limited to a single instruction control console 210.

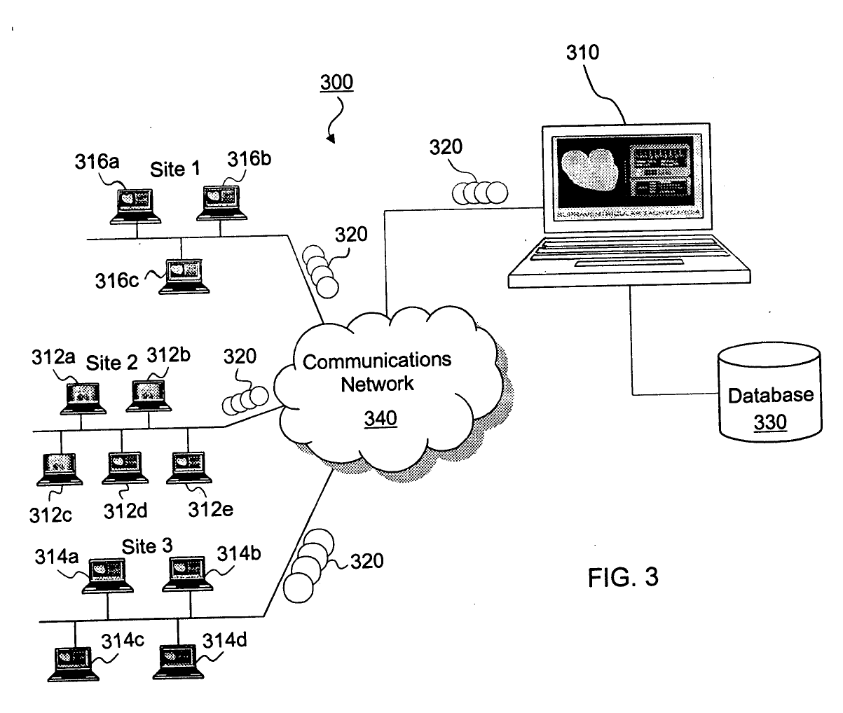

FIG. 3 illustrates a medical instruction system 300. The system 300 includes a instructor console 310. The instructor console 310 provides data 320 from database 330 for distribution across communications network 340. In one embodiment, the instructor console 310 is in communication with multiple sites (Site 1, Site 2, and Site 3). Each site includes multiple student consoles 312, 314, and 316. One configuration downloads student specific information to each student console. Thus as a student progresses in instruction less prompting is required. Another configuration instructs each student console 314 and 316 to closely follow the instructor console 310. Yet another configuration allows each student console 312a-e to independently select their course of study.

In one embodiment, the database 330 is directly accessible via the communications network 340 by the student consoles 312, 314, and 316. Depending on the mode of operation, the instructional database 330 can also be accessed through wireless communication channels by the student and instructor consoles 310, 312, 314, and 316. This configuration is particularly useful when used with mobile reference consoles. A display device on the mobile console can guide a medical professional step by step through a desired medical procedure.

Thus an individual may utilize the interactive virtual patient to simulate an individual patient's presentation, evaluation, diagnosis, and treatment of a hypothetical illness, while intermittently providing internal animated views of the human body to enable viewers to integrate an internal visualization of the human body into patient care algorithms FIGS. ***4-14 provide exemplary screen shots from a display device, which though unable to completely illustrate the dynamic nature of the instructional data do provide an adequate foundation for one of skill in the art to practice the present invention.

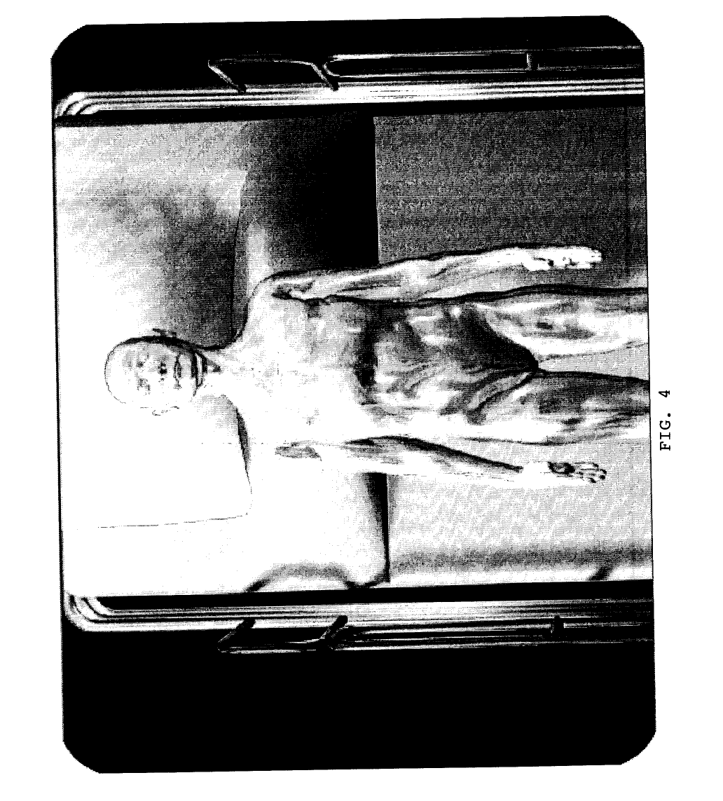

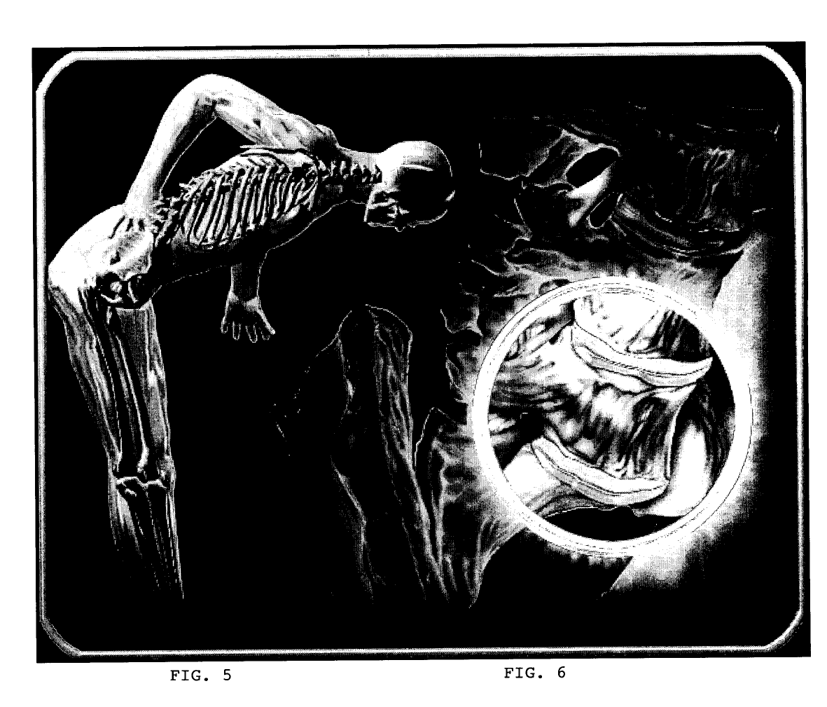

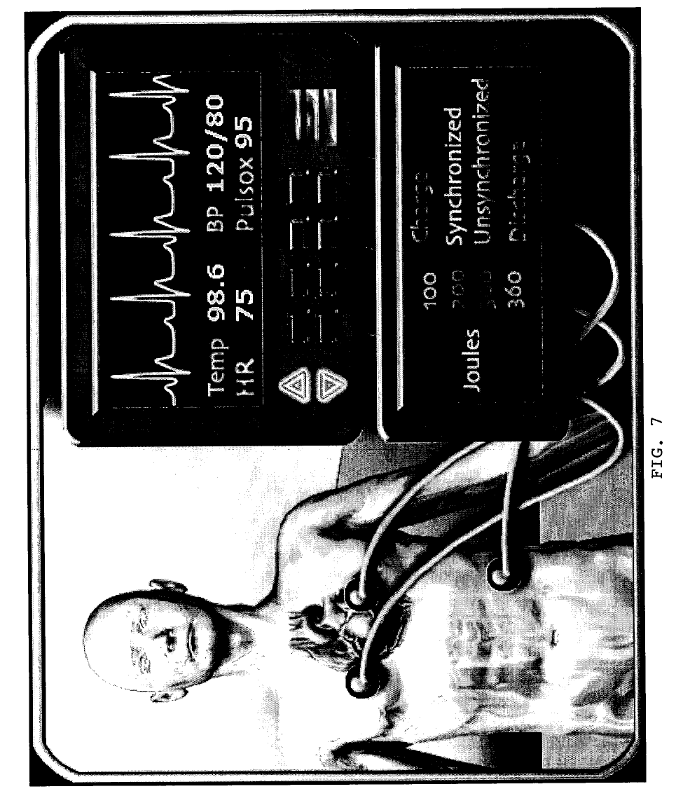

FIGS. 4 to 6 illustrate views of a virtual patient exhibiting painful symptoms. More specifically, FIG. 4 illustrates a virtual patient with abdominal pain and FIGS. 5 and 6 illustrate a virtual patient with a herniated disk highlighting the affected region. Preferably, the regions of pain on the virtual patient are emphasized in red. In one configuration using an instructor mode, an instructor creates a hypothetical scenario of a patient and, together with audience input, guides the patient through a simulated medical evaluation and course of treatment. The instructor begins by giving a brief verbal history e.g. “a 52 year old man with chest pain”. The instructor, then clicks the mouse over the body part (chest), which then lights up in red to simulate pain. The audience is then encouraged to evaluate the patient by asking questions, to which the figure may nod negatively or affirmatively by the instructor striking the proper inputs, i.e., on-screen buttons or keyboard keys. The instructor can worsen the patient's condition, e.g., have the pain radiate to the arm or have the patient sweat or even collapse if the appropriate simulated interventions (e.g., place IV, place patient on a cardiac monitor) are not suggested in a timely manner by the audience. A clock on the screen can be set to run in real time or may be manipulated by the instructor to simulate alternative time patterns.

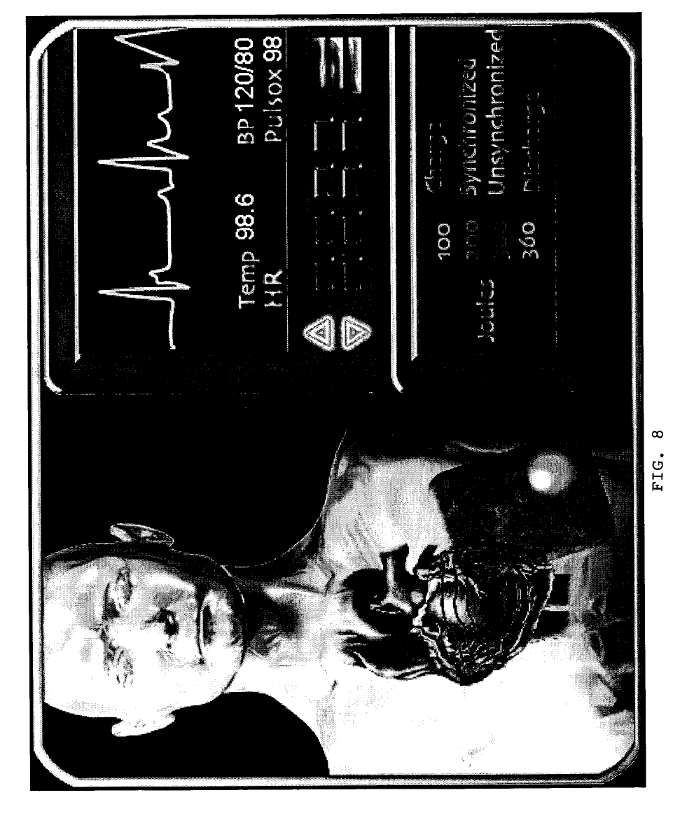

FIG. 7 illustrates a virtual patient with a telemetry box that includes a cardiac monitor along with other vital signs. In the instructor mode, the instructor may click on various buttons to receive additional information. For example, buttons may provide chart excerpts, radiology reports, medications, EKG, and other information. Exemplary x-rays might include a normal chest, a congestive heart failure (CHF), a bilateral pneumonia, a pneumothorax (simple), a pneumothorax (tension), a chest tube, a normal intubation, a right main stem intubation, and a wide mediastinum.

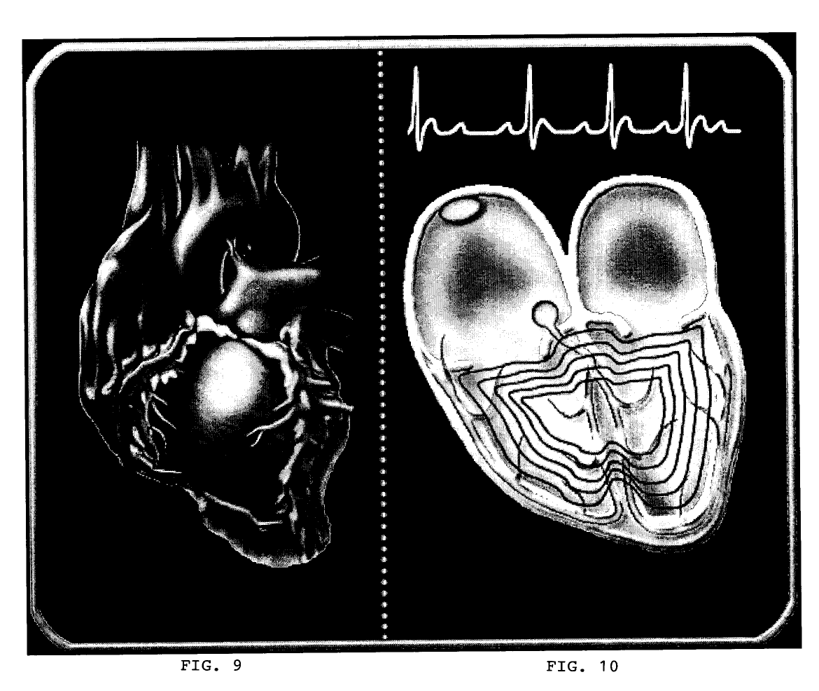

Once a simulated intervention is selected, the view will illustrate the application and effect of the intervention on the virtual patient. For example, FIG. 8 illustrates a virtual patient with an external pacer and a cardiac monitor. The virtual patient heart is shown responding to electrical pulses from the external pacer.

FIG. 9 and 10 provide different views of a virtual heart. The first view, FIG. 9, is a simulation of a beating heart. The second view, FIG. 10, is a cardiac monitor showing the heart rhythm and a diagrammatic schematic showing electrical conduction within the heart.

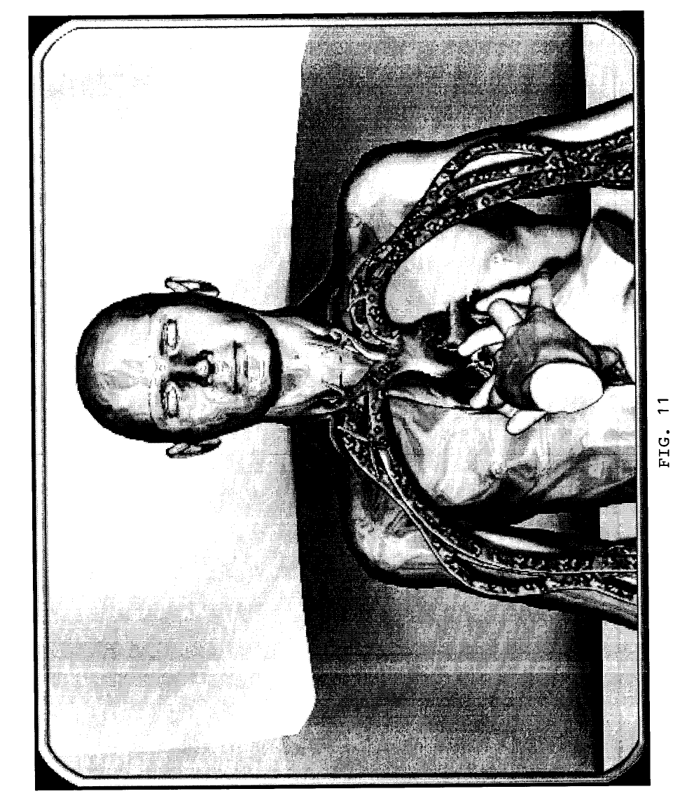

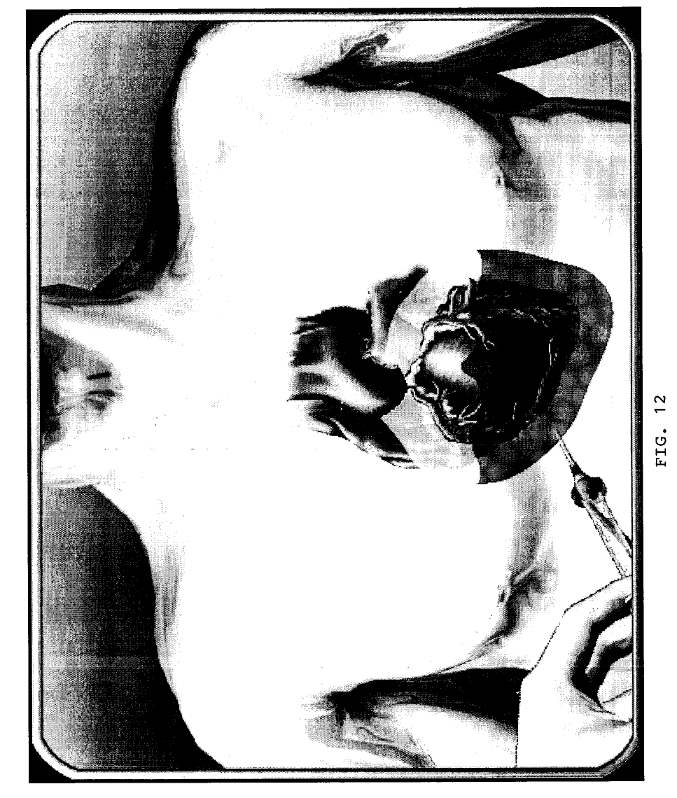

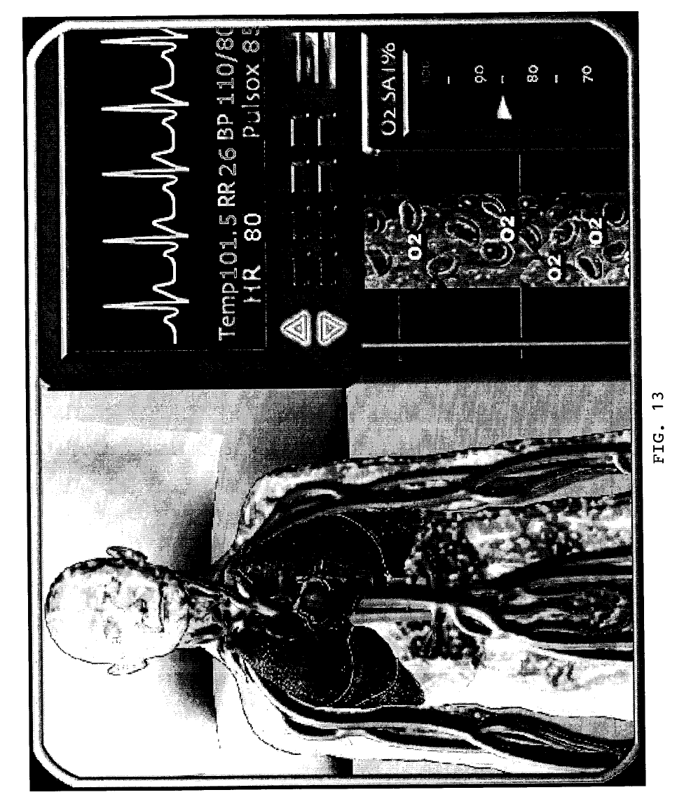

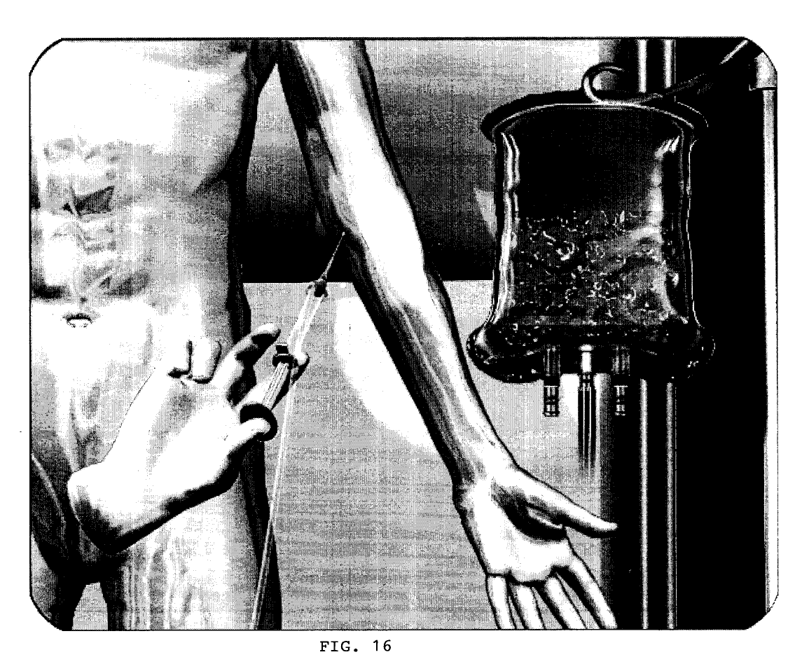

Another exemplary intervention is administering CPR to a virtual patient, as illustrated in FIG. 11. One can observe the proper placement of the hands to compress the chest and force the blood to flow through the body. Another heart related intervention is pericardial centesis, as illustrated in FIG. 12. Other available interventions include a variety of intubations (FIG. 15) and intravenous infusions (FIG. 16) of a virtual patient.

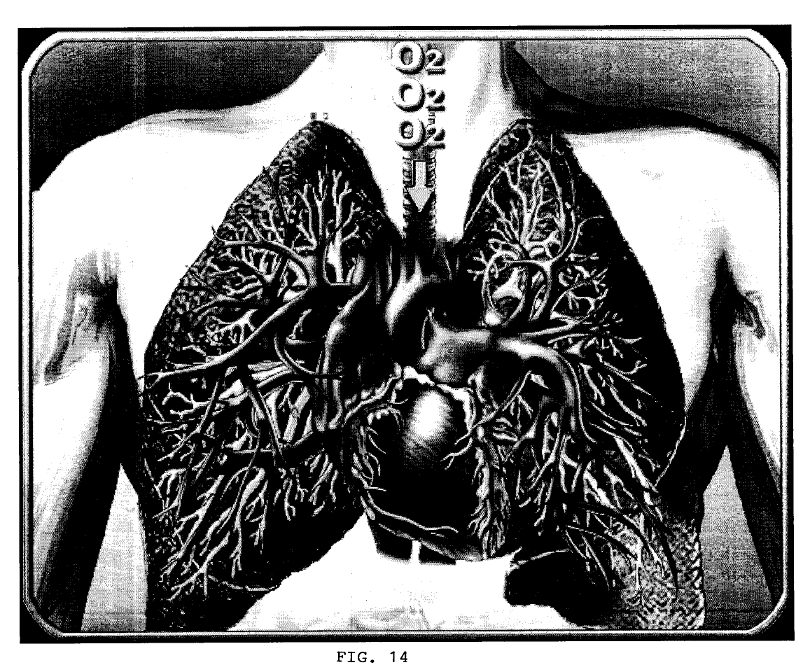

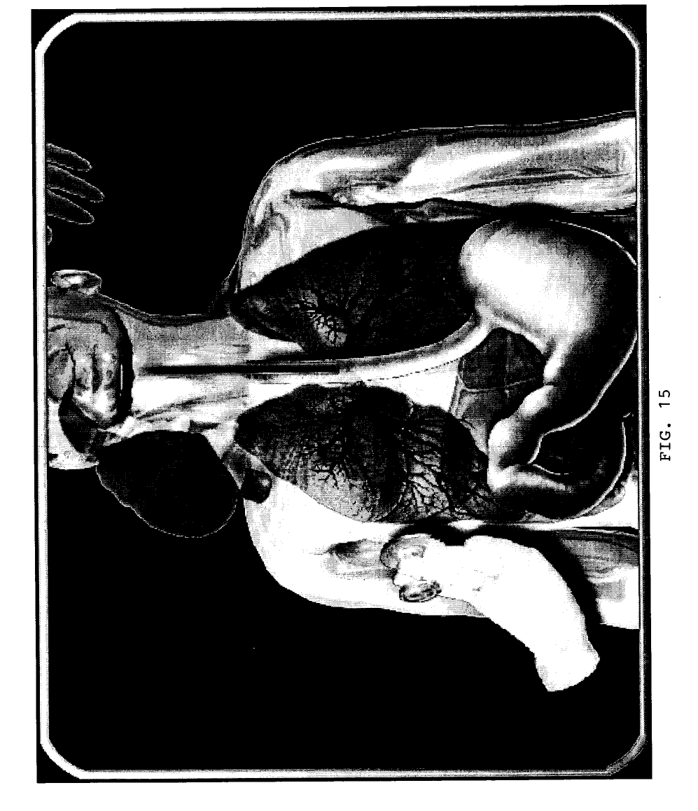

The virtual patient may also give visual symptoms helpful in the diagnosis of the medical condition, for example, fainting or sweating. FIG. 13 provides a heavily sweating virtual patient being monitored for oxygen content in the blood with an oximeter. The normal functioning of a system must often be understood before a problem can be discovered. As such, the virtual patient may also illustrate normal physiology. FIG. 14 provides a graphical representation of cardiopulmonary physiology in a virtual patient.

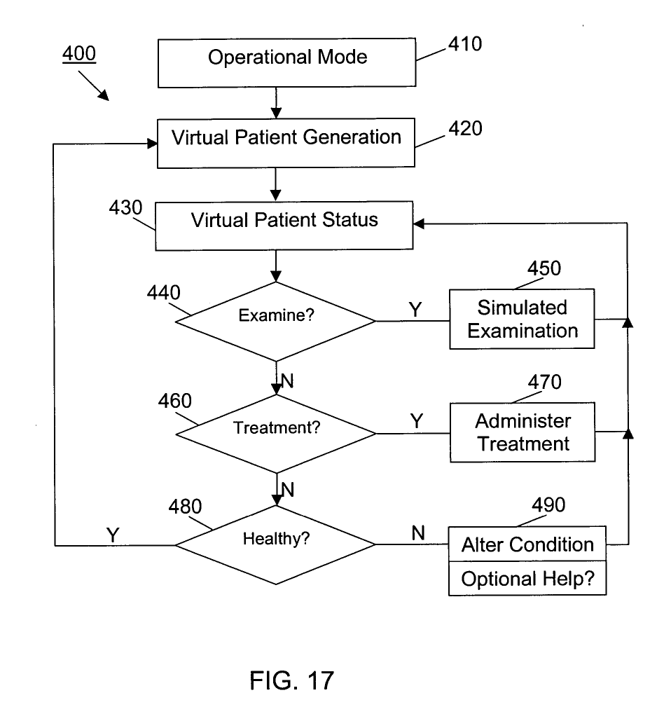

Turning now to FIG. 17, particular methods of various embodiments are described in terms of computer software and hardware with reference to a flowchart. The methods to be performed by an electronic device constitute digital logic or computer programs made up of computer-executable instructions. Describing the methods by reference to a flowchart enables one skilled in the art to develop such programs including such instructions to carry out the methods on suitably configured electronic devices (the processor or micro-controller of the computer or game console executing the instructions from computer-accessible media).

The computer-executable instructions may be written in a computer programming language or may be embodied in firmware logic. If written in a programming language conforming to a recognized standard, such instructions can be executed on a variety of hardware platforms and for interfaces to a variety of operating systems.

It will be appreciated that a variety of programming languages may be used to implement the wireless controller system as described herein. Furthermore, it is common in the art to speak of software, in one form or another (e.g., program, procedure, process, application . . . ), as taking an action or causing a result. Such expressions are merely a shorthand way of saying that execution of the software by an electronic device causes the processor of the computer or instructional console to perform an action or a produce a result.

FIG. 17 is a flowchart that illustrates one embodiment of a medical instructional system 400. Initially, the system 400 selects an operational mode in block 410. Exemplary operational modes include instructor mode, student learning mode, student evaluation mode, medical reporting (legal) mode, media mode, and medical demonstration (pharmaceutical/medical device) mode.

In the instructor mode, an instructor creates a hypothetical scenario of a patient and together with audience input, guides the patient through a simulated medical evaluation and course of treatment. The student-learning mode is a self-contained module designed for the student to work alone or with others on the computer to diagnose various mystery ailments without the aid of an instructor. In the student evaluation mode, a running clock is added to the device and used to determine whether the student makes critical interventions on behalf of the virtual patient within a preset period. The medical reporting (legal) mode uses an interface for the virtual patient that may be customized to represent an actual patient as reflected in the patient's medical chart. In media mode, members of the media extract media clips excerpts from a full version of the virtual patient to teach the public about unfamiliar health conditions through dynamic illustrations. The medical demonstration (pharmaceutical/medical device) mode allows the virtual patient to demonstrate the internal effects of various medical devices and medications.

Upon selecting an operational mode 410, the system 400 generates a virtual patient in block 420. In one embodiment, generating a virtual patient includes obtaining a generic history including age, gender, race, allergies, and supplementing the generic history with other “condition specific” information, such as high temperature, abdominal pain, etc. The type of virtual patient established may also be based on the operational parameters of the selected operational mode. For example, in student mode, a student may request additional practice in a specific area and need more details or severe symptoms to determine the mystery condition. Alternatively, in the student evaluation mode, uniform pre-established conditions may be used and the student responses are timed to ensure timely intervention. Once the virtual patient is generated in block 420, the system 400 provides the status of the virtual patient in block 430.

The status is based in part on the medical condition affecting the virtual patient. Exemplary medical conditions include, but are not limited to, cardiac arrest, ACS/AMI, CHF, DVT/PE, aortic dissection, pericardial tamponade, pneumothorax (tension & simple), asthma, pneumonia, appendicitis, AAA, perforated viscous, GI bleed (upper & lower), bowel obstruction, mesenteric ischemia, cholycystitis, renal colic, testicular torsion, TIA/CVA, seizure, and meningitis. The virtual patient will take on characteristics consistent with the medical condition.

From the status block 430, the system 400 may select a course of action. In Query block 440 a decision is made whether to perform a simulated examination. If it is determined that the virtual patient requires examination, the exam is conducted in block 450. The examination may include heart, lung, epigastria, neck, and radiological examinations. Ancillary testing may include requesting x-rays, CT scans, MRIs, EKGs, and additional laboratory data. Following the examination, the system 400 returns and reports the status of the virtual patient in block 430. Query block 460 determines whether to administer a course of treatment. If treatment is selected, then execution block 470 administers the selected treatment to the virtual patient and may provide dynamic internal views and external views of organs and systems affected by an administered treatment. Exemplary treatments include, but are not limited to, medication, CPR, defibrillation, needle decompression, EKG, and intubations. Other treatments may be added to the system in conjunction with the addition of applicable medical conditions. In this manner, the virtual patient can be customized to the needs and interests of the medical professional.

Available medications include, but are not limited to, saline, adenosine, nitroprusside, dilitazem, epinephrine, amiodarone, thrombolytics, atropine, heparin, enoxaparin, furosemide, beta blocker, nitroglycerine, and aspirin. Additional medications may be easily added either to correspond with added medical conditions or with a recommended course of action.

Upon completing treatment in block 470 the system 400 returns to status block 430. If no further examinations or treatments are desired, the system 400 checks to see if the virtual patient is “healthy” in query block 480. If query block 480 determines that the generated medical condition has been “cured” or at least treated, the system 400 returns to execution block 420 to generate a new patient. If, however, the medical condition remains undiscovered, then execution block 490 performs an operational mode specific action, such as altering or aggravating the symptoms of the virtual patient. Optionally, execution block 490 may provide additional help through dynamic internal views and external views of the organs and the systems affected by the mystery medical condition. In one configuration, the virtual patient assumes that the health professional is unfamiliar with the condition and provides a brief tutorial concerning the condition. Execution block 490 returns to the status block 430 and the health professional is given an additional opportunity to diagnose and treat the virtual patient.

In one embodiment, the instructor mode allows an instructor to create a hypothetical scenario of a virtual patient and, together with audience input, guides the virtual patient through a simulated medical evaluation and course of treatment. The instructor begins by giving a brief verbal history e.g. a 52 year old man with chest pain.” The instructor clicks the mouse over the body part (chest), which then will light up in red to simulate pain. The audience is then encouraged to evaluate the patient by asking questions, to which the figure will nod negatively or affirmatively by the instructor striking the proper keyboard keys. The instructor can worsen the patient's condition, e.g., have the pain radiate to the arm or have the patient sweat or even collapse if the appropriate simulated interventions (e.g., place IV, place patient on a cardiac monitor) are not suggested in a timely manner by the audience. A clock on the screen can be set to run in real time or may be manipulated by the instructor to simulate alternative time patterns.

As the audience selects interventions (e.g., place an IV), a button on the screen is prompted and a movie of that action is launched in order for the audience to better visualize the procedure, generally combining both an external and internal view of the body. Once the cardiac monitor has been selected, the instructor chooses any of the normal and abnormal heart rhythms that the human heart is capable of. The rhythms are replications of representative patients and run in real time to simulate an actual human heart. The various rhythms all correspond to single keyboard keys and can be brought on or changed with the touch of a key. Vital sign parameters including blood pressure, heart rate, respiratory rate, temperature, and oxygen content (as reflected in the pulse oximeter) are all controlled and coded to individual keys on the keyboard and can be altered with a single key touch at any time during the scenario.

The audience can prompt the instructor to perform simulated physical examinations of the virtual patient of any organ system. Examples include, but are not limited to, examining the lungs for various types of normal and abnormal breath sounds. The instructor can chose to change those sounds later on in the scenario in response to other actions taken by the audience, e.g., fluid collecting in the lungs as a result of an excessive administration of intravenous fluid. All organ systems including cardiac, pulmonary, gastrointestinal, nervous, and orthopedic can undergo detailed simulated physical examination.

The audience can prompt the instructor to perform ancillary testing including X-rays, CT scans, MRIs, and EKGs and laboratory data. In one configuration, these studies may be selected from a popup menu that conceals the interpretation from the audience. For example, one x-ray on the popup menu would be a representative x-ray of a collapsed lung. Representative laboratory data, including blood and urinary analysis can also be made available to the audience. The “medication” menu would, again, contain commonly used medications listed in a popup format concealed from the audience that would not prompt any specific choices. For example, the medication “medication2” would prompt the infusion of epinephrine (so labeled in the instructors user guide) but not visible to the audience. This more closely simulates real life decision-making where one's choices are usually not prompted by a visible list from which the correct option can be chosen. The correct interpretation of this ancillary information in a timely fashion drives the management of the patient. For example, if the representative EKG shown by the instructor demonstrates that the patient is suffering from a heart attack, the audience must choose to administer the appropriate medications, or the instructor will simulate an untreated heart attack patients condition, including pushing buttons to simulate worsening symptoms of chest and arm pain, sweating, nausea, and eventual collapse. The heart rate, respiratory rate blood pressure and cardiac rhythm will all worsen, as would an actual patient.

Representative interventions beyond vital sign measurement and cardiovascular monitoring are designed to simulate modem acute medical care. They include, but are not limited to, placing IVs, applying pacemakers, draining fluid from the heart, performing CPR, shocking the heart with electricity, applying oxygen to the patient, placing a tube within the trachea to assist breathing, and introducing a needle or tube into the chest wall to allow a collapsed lung to re-inflate. Again these interventions are guided by the audience and prompted on the keyboard by the instructor. The timing of the procedures as well as their appropriateness given the current scenario, determine the course of the patient. Even proper interventions, performed at the appropriate response can be simulated to lead to commonly encountered simulated complications. For example, the audience may prompt the instructor to pass a breathing tube down the patient's trachea, but the tube may pass beyond the region that is midway between both lungs and into the airway of the right lung. The audience must detect this complication by re-evaluation (re-examination of the lungs) or the instructor will show the oxygen level of the patient gradually decline until this complication is detected. At any time, the instructor can prompt the audience to choose the correct intervention, discourage an action, or have the patient deteriorate of not treated appropriately until a simulated death occurs. If managed appropriately, the patient will recover from each simulated ailment.

At any time during any portion of this simulated medical evaluation or treatment, the model contains an ability view the patient's body internally. If the patient simulation is one of a right lung collapse, the instructor can access a library of animated “clips,” each approximately 10-55 seconds in length that demonstrate an internal view of that condition or treatment. For the collapsed lung, an instructor can launch an animated visualization of a lung collapsing by accessing this clip library within the system. Likewise, the procedure of placing a tube through the chest wall to expand the lung can be launched as well. The x-ray representation of this condition is also shown superimposed on the animated lung in order to highlight the overlay of the disease process demonstrated by the animation with an actual x-ray. As medications are administered, the appropriate animation can be accessed that demonstrates a schematic illustration of that medication on the tissue and function of that organ. This library of animations is designed to demonstrate a visual representation of the internal human body during any medical illness, its evaluation, diagnosis and treatment.

In one embodiment, the system operates in a student-learning mode, this mode would be a self-contained module designed for the student to work alone or with others on the computer and would not require an instructor as previously described. The system would contain a menu of mystery ailments, e.g., Pneumonia. The student would be presented with a male patient with a brief text history, e.g., 52 year old male with fever, chest pain, and cough.

The system would then prompt the student to begin his evaluation. If the student requested vital signs, the system would provide all the conventional vital signs including an elevated temperature. If the student chooses to examine the lungs, the system will provide the simulated lung sounds characteristic of pneumonia. If the student orders a chest x-ray, the system will provide a representative x-ray of pneumonia. There will be certain critical interventions that the student must make in order for the virtual patient to improve. The first would be to recognize that the patient requires oxygen. This could be detected by the student evaluating the patient's oxygen level by either a blood test or an oxygen-sensing device placed on the finger (pulse oximeter). If the low oxygen level (preset into the system) is detected and corrected, then the increased respiratory rate will improve, if not, the patients vital signs will remain abnormal and worsen over a fixed period unless supplemental oxygen is prompted to be given. Likewise, antibiotics must be administered as well, or the temperature will continue to rise. If the student fails to ask the patient about allergies to any medications, a sequence of an allergic reaction will launch and will continue to worsen unless the student administers the appropriate medicines to treat the allergic reaction. In order for the patient to be treated successfully, the necessary interventions must be made for each arm of the algorithm. In order for the student to better understand the evaluation of these medical conditions and treatments, the system can launch animations to allow the student to view the internal portions of the body at any time during the exercise. E.g., view internal view of chest to visualize the pneumonia process. First, the lung tissue could be visualized with the infected tissue becoming discolored with infection. Then a dynamic visual schematic of pulmonary function would illustrate how the diseased portion of the lung causes a decrease in the oxygen content of the blood. When the student chooses to apply oxygen as a treatment, the student can also click onto an internal animation of the physiological effect of that oxygen with both the lung tissue and the bloodstream itself. Finally, the student can launch an animation of the antibiotic, seeing the antibiotic travel into the bloodstream and then trace it down to the cellular and molecular level to understand its mechanism of action in fighting the infection.

In another embodiment, the system operates in a student evaluation mode. For example, the system configuration previously described above could be modified into an evaluation tool by adding a running clock to the device. A preset time could be determined in order for the student to make critical interventions in order to receive a satisfactory evaluation. There would be an algorithmic design that would allow the student to reach the necessary endpoint before moving forward in the exercise. For example, if the low oxygen level was not corrected by giving the patient oxygen, the vital signs (respiratory rate, heart rate, blood pressure) would progressively deteriorate until that intervention was made or the patient would suffer a respiratory collapse that would require additional intervention or that evaluation module would end in the patients expiration and end. Efficiency scores could be calculated based on the efficiency with which the student performed the necessary functions, i.e., chose the fewest possible actions in order to move to the next necessary treatment step. This efficiency score coupled with the total time to complete the patient's treatment would provide the objective basis of evaluation.

Following the evaluation, the student could review their deviation from the predetermined most efficient path through the algorithm. In addition, the student could launch internal animations that correspond to the specific treatments in order to visualize internally, the condition, evaluation process (e.g., the student could visualize a collapsed lung within the chest as they hear the decreased breath sound through the virtual stethoscope), in order to reinforce the visual connection between evaluation and treatment and what occurs within the body.

In another embodiment, the device operates in a medical-legal mode. The medical legal mode includes an interface that may be customized to represent an actual patient as reflected in the patient's medical chart. In this configuration, the calendar and clock on the screen help chronicle the events as they occur to the patient. For example, Mr. Jones, a 64 year old man, arrived at Holy Cross Hospital on Feb. 12, 2002 at 7:20 am complaining of chest pain radiating to the left arm. A generic image of an adult male is represented on the screen. Either the attorney or an expert witness clicks the appropriate time and date information onto that area of the screen. The user scrolls over the patient's chest clicks a red dot and the same on the left arm causing those areas to glow in red to simulate pain. If the chart reflects that, 3 minutes later, the patient became sweaty, the attorney/expert witness may adjust the reading on the clock, and then click on a button that simulates sweating. If an EKG was performed at 8:02 am, the clock may be adjusted and a scanned image of the actual EKG is selected to appear on the screen. Other interventions including aspects of the physical examination are simulated using the model, e.g., the doctor's note records that the patient was wheezing (the virtual stethoscope will travel to the chest and the audience will hear a representative wheezing noise) so that the jury can understand the term wheeze. As medications were administered during the course of treatment, the attorney adjusts the clock to reflect the record, and then launches a schematic of medications entering the body either by mouth or intravenously. During any portion of this presentation, the attorney can launch an animation that visualizes the internal body during that particular phase of the evaluation or treatment. For example, a visualization of how nitroglycerine helps dilate the vessels of the heart shown directly after the attorney/expert witness chronicles the administration of nitroglycerine to Mr. Jones by the nurse at 8:20 am as reflected in the chart. This mode allows an attorney to create a visualization of the medical evaluation and treatment as reflected in the chart as well as the ability to create a visual understanding of the human body during this process.

In another embodiment, the virtual patient operates in a media mode. This media mode allows members of the media to extract excerpts from the Virtual Patient in order to teach the public about unfamiliar health conditions. For example, a reporter may select graphics that simulate appendicitis symptoms, e.g., showing the figure's abdomen glow in red to simulate pain, showing the figure's exterior change to a faint red hue to simulate fever, showing vomiting, and showing an examining hand push the abdomen. As part of the examination, the internal organs fade in to demonstrate the location of the appendix. The reporter can be giving statistics of interest to the public about number of cases of appendicitis per year in the USA and how many go undiagnosed. The visualization of the appendix will continually repeat in a loop to show rupture, the internal effects of rupture, and the changes in the patients appearance and physical examination as well. This same type of presentation could be used to explain the medical condition of someone in the public eye who had just suffered a hightly publicized illness. For example, David Bloom's pulmonary embolus.

In one embodiment, the virtual patient operates in a medical demonstration mode. In this mode, the virtual patient can demonstrate the internal effects of various medical devices and medications. The virtual patient is configured to experience symptoms like chest pain. An exemplary EKG can be shown to reveal a heart attack and, in response, a medication can be given. The virtual patient allows a visualized schematic to illustrate how that drug effects the internal portion of the heart and resolves the blockage in the heart. Additionally, a medical device such as a pacemaker could be demonstrated in a similar fashion. Starting with the erratic heart and continuing to the interaction of the pacemaker with the heart to normalize the rhythm.

The present invention may be embodied in other specific forms without departing from its spirit or significant characteristics. The described embodiments are to be considered in all respects only as illustrative and not restrictive. Therefore, the scope of the invention is indicated by the appended claims rather than by the foregoing description. All changes that come within the meaning and range of equivalency of the claims are to be embraced within their scope.

What is claimed is:

1. A method which comprises the following steps:
electronically determining a medical condition for a virtual patient;
electronically simulating a medical examination on the patient; and
electronically administering at least one course of treatment on the virtual patient.

2. The method according to claim 1, wherein the step of simulating the medical examination includes providing dynamic internal views and external views of organs and systems associated with the medical condition.

3. The method according to claim 2, which further comprises selecting the medical condition from the group consisting of cardiac arrest, ACS/AMI, CHF, DVT/PE, aortic dissection, pericardial tamponade, pneumothorax (tension & simple), asthma, pneumonia, appendicitis, AAA, perforated viscous, GI bleed (upper & lower), bowel obstruction, mesenteric ischemia, cholycystitis, renal colic, testicular torsion, TIA/CVA, seizure, and meningitis.

4. The method according to claim 1, wherein the step of simulating the at least one course of treatment includes medicating the virtual patient and providing dynamic internal views and external views of organs and systems affected by an administered medication.

5. The method according to claim 4, which further comprises selecting the medication used in medicating the virtual patient from the group consisting of saline, adenosine, nitroprusside, dilitazem, epinephrine, amiodarone, thrombolytics, atropine, heparin, enoxaparin, furosemide, beta blocker, nitroglycerine, and aspirin.

6. The method according to claim 1, which further comprises visually indicating, with the virtual patient, at least one location of pain associated with the medical condition during the medical examination.

7. The method according to claim 1, wherein the step of electronically providing the medical condition includes altering a severity of the medical condition according to one of the at least one course of treatment and a timeliness of response in administering at least one preferred course of treatment.

8. The method according to claim 1, wherein the simulated medical examination includes performing ancillary testing selected from the group consisting of x-rays, CT scans, MRIs, EKGs, and laboratory data.

9. The method according to claim 1, wherein the step of simulating the at least one course of treatment includes performing a procedure selected from the group consisting of CPR, defibrillation, needle decompression, EKG, and intubations.

10. A system for indicating an electronic dynamic human body and simulating interactive patient care and treatment, the system comprising:
an instructional database containing data for at least one medical condition having dynamic internal views and external views of organs and systems relevant to the medical condition and data for at least one patient profile;
an instructional processing device electronically connected to the instructional database, the processing device being configured to generate a virtual patient from the data of a selected patient profile and to simulate a medical examination and at least one course of treatment; and
an input control device electronically connected to the processing device to generate control signals interacting with the virtual patient and to alter the simulated medical examination and the simulated at least one course of treatment.

11. The system according to claim 10, further comprising a display device electronically connected to said processing device configured to visualize the effects of the simulated medical examination and the simulated at least one course of treatment on the virtual patient through dynamic internal views and external views of organs and systems.

12. The system according to claim 10, further comprising:
a communications network electronically connected to the instructional processing device; and
multiple instructional consoles electronically connected to the communications network, each console observing the virtual patient and the simulated medical examination and the simulated at least one course of treatment.

13. The system according to claim 12, wherein the multiple instructional consoles each provide feedback containing a suggested course of treatment to the instructional processing device.

14. The system according to claim 10, wherein the instructional processing device includes a clock and the virtual patient is generated from data based on a real patient medical history, the virtual patient receiving the at least one course of treatment provided in the medical history.

15. An apparatus for medical instruction, comprising:
a machine readable medium containing instructions which, when executed by a machine, cause the machine to perform operations including:
generating a medical condition for a virtual patient; and
administering a simulated medical examination on the patient, the simulated medical examination having dynamic internal views and external views of organs and systems relevant to the medical condition.

16. The apparatus according to claim 15, wherein the machine readable medium contains instructions that cause the machine to administer at least one course of treatment on the virtual patient based in part on the simulated medical examination.

17. The apparatus according to claim 16, wherein the at least one course of treatment includes medicating the virtual patient.

18. The apparatus according to claim 17, wherein the machine readable medium contains instructions that cause the machine to observe the simulated effect of medicating the virtual patient on the medical condition with at least one dynamic internal view and at least one external view.

19. The apparatus according to claim 15, wherein the simulated medical examination is conducted according to information provided in a medical history of a real patient and the reactions of the virtual patient correspond to the reactions of the real patient recorded in the medical history.

20. The apparatus according to claim 15, wherein the machine readable medium contains instructions that cause the machine to alter a severity of the medical condition according to a timeliness of response in providing a preferred course of treatment.
